(19) United States
(12) Patent Application Publication
(10) Pub. No.: US 2005/0163185 A1
(43) Pub. Date: Jul. 28, 2005

(54) Surface functionalization of micro-resonators

(76) Inventors: Kerry J. Vahala, Pasadena, CA (US); Lan Yang, Pasadena, CA (US); Deniz K. Armani, Burbank, CA (US)

Correspondence Address: Bingham McCutchen LLP, Suite 1800, Three Embarcadero Center, San Francisco, CA, 94111-4067, US

(21) Appl. No.: 11/016,067

(22) Filed: Dec. 17, 2004

Related U.S. Application Data
(63) Continuation-in-part of application No. 10/678,354, filed on Oct. 2, 2003.
(60) Provisional application No. 60/415,412, filed on Oct. 2, 2002.
(60) Provisional application No. 60/542,764, filed on Feb. 5, 2004.

(51) Int. Cl. H01S 3/06

(52) U.S. Cl. 372/67

(57) ABSTRACT

A micro-cavity resonator including a micro-cavity having a doped sol gel layer or solution applied thereto. The dopant can be various rare earth elements, such as erbium. The micro-cavity can be a spherical or disk or toroid shaped micro-cavity. Certain cavities are capable of high and ultra-high Q factors. Optical energy travels along an inner surface of the coated micro-cavity at a wavelength influenced or determined by the dopant in the coating.

### CROSS-REFERENCE TO RELATED APPLICATIONS

This application claims priority under 35 U.S.C. §119 to U.S. Provisional Patent Application No. 60/542,764, filed Feb. 5, 2004, the entire disclosure of which is incorporated herein by reference as though set forth in full. This application is also a continuation-in-part (CIP) of U.S. application Ser. No. 10/678,354, filed Oct. 2, 2003, priority of which is claimed under 35 U.S.C. §120, which claims priority under 35 U.S.C. §119 to U.S. Provisional Patent Application No. 60/415,412, filed Oct. 2, 2002, the entire disclosures of which are incorporated herein by reference as though set forth in full.

### STATEMENT REGARDING FEDERALLY SPONSORED RESEARCH

The U.S. Government has certain rights in this invention pursuant to Grant No. N00014-00-1-0650 awarded by the Office of Naval Research and Grant No. DMR-0103134 awarded by the National Science Foundation.

### FIELD OF THE INVENTION

The present invention is directed to micro-cavity resonators, more particularly, to micro-cavity resonators having a coating or layer of a doped sol gel solution.

### BACKGROUND

Various micro-cavity resonators have been utilized to re-circulate light and store optical power. In a typical micro-cavity resonator, light traverses around an interior surface of the cavity. Optical power stored in the resonator and can be used in cavity quantum electrodynamics (cQED), photonics, and various optics applications. The surface quality and of the micro cavity surfaces finish usually affect how long light can re-circulate in the resonator which, in turn, affects the Q factor of the micro-cavity.

The “Q factor” or “Q value” measures the stability of light within a resonator. In other words, the Q factor measures the relationship between stored energy and the rate of dissipation of the energy. For example, known micro-cavities include surface-tension induced micro-cavities (STIM), such as droplets or micro-spheres.

Micro-cavities having higher Q factors can store light energy for longer periods of time compared to micro-cavities having lower Q factors. Micro-cavities with higher Q factors are also typically more sensitive compared to lower Q factor cavities. For purposes of explanation and to establish a point of reference, a “high” Q factor is generally considered to be a Q factor up to about one million or 10⁶, and an “ultra-high” Q factor is generally considered to be a Q factor greater than one million. Indeed, this frame of reference is not intended to be limiting.

Some spherical resonators have been immersed in a coating with the effect that the coating alters the manner in which the spherical resonator functions. For example, U.S. Pat. No. 6,657,731 describes a miniaturized chemical sensor that has a spherical cavity. The spherical cavity is coated with a surface layer. The surface layer chemically interacts with a molecule species (in a fluid or a gas) surrounding the micro-cavity, so as to alter the coupling of light between the spherical cavity and a waveguide. Specifically, the chemical interaction causes a change in the index of refraction of the micro-cavity, which alters the phase difference acquired by resonant light circulating in the spherical cavity.

Other techniques, such as the process described in “Thermooptical Switches Using Coated Microsphere Resonators,” by H. C. Tapalian et al., involve coating a silica microsphere with a conjugated polymer coating by dipping the sphere into a toluene solution of polymer (2,5-dioctyloxy-1,4-phenylene vinylene) for use as an optical switch.

Known coated resonators and the manner in which they are fabricated can be improved. For example, the ability to selectively functionalize surfaces of micro-cavity resonators should be provided so that the resonators can be used with various wavelengths, components and applications. Further, there should be an ability to functionalize surfaces of micro-cavities having various shapes and sizes, including spherical and other shaped resonators. Thus, coating applications should not be limited to particular geometries. Further there should be an ability to functionalize surfaces of micro-cavities that can be fabricated with traditional wafer-based processing techniques and equipment since some spherical resonators can be limited in their integration with other components.

There is also a need for an ability to functionalize micro-cavity surfaces with materials that are compatible with optical applications and related dopants for use with various optical applications. Thus, resonator coating should not be limited to certain polymer and chemically reactive coatings for spherical resonators. Moreover, such micro-cavities should be fabricated in a time and cost efficient manner and be of a form that can be integrated with planar circuits and standard microelectronics components and fabrication techniques.

### SUMMARY

In one embodiment, a micro-cavity resonator includes an optical micro-cavity, a dopant; a sol gel solution. The sol gel solution hosts the dopant, and a portion of the micro-cavity is coated with the doped sol gel solution. Optical energy travels along an inner surface of the coated micro-cavity at a wavelength that is influenced by the dopant in the sol gel coating.

In another embodiment, a micro-cavity resonator includes a spherical optical micro-cavity, a sol gel solution and a dopant. The sol gel solution hosts the dopant, and a portion of the spherical micro-cavity is coated with the doped sol gel solution. The doped sol gel coating functionalizes a gain of the spherical micro-cavity, and optical energy travels along an inner surface of the coated micro-cavity at a wavelength influenced by the doped sol gel coating.

In a further alternative embodiment, a micro-cavity resonator includes a micro-cavity, a substrate, a sol gel solution and a dopant. Portions of the substrate that are located below the micro-cavity are removed to form a pillar, which supports the micro-cavity. The sol gel solution includes the dopant and at least a portion of the micro-cavity is coated with the doped sol gel solution. Optical energy travels along an inner surface of the coated micro-cavity and has a wavelength influenced by the dopant in the sol gel coating.

In yet a further alternative embodiment is a method of functionalizing a surface of a micro-cavity, a sol gel solution and a dopant are provided. The dopant is introduced into the sol gel solution, and a portion of the micro-cavity is coated with the doped sol gel solution. Optical energy travels along an inner surface of the coated micro-cavity at a wavelength that is influenced by the dopant in the sol gel coating.

In various embodiments, the dopant is a rare earth element, such as erbium. For example, the concentration of erbium in the sol gel solution can be about 10¹⁹ to 10²² cm⁻³ and an erbium doped sol gel solution coated micro-cavity can emit an output at a wavelength of about 1.5 to 1.6 micrometers.

Further, the thickness of the sol gel coating can be at least about 0.5 micrometer.

Depending on the type of resonator, the Q factor can range from about 10⁶ to 10⁸.

The micro-cavity can be silica and be various shapes and sizes. For example, the micro-cavity can be planar, spherical, or toroid-shaped.

For example, a spherical micro-cavity can have a diameter of about 25 to 200 μm and a thickness of the doped sol gel coating can be at least about half micrometer.

As a further example, a toroid-shaped micro-cavity supported by a substrate can have a thickness of about 0.5 to about ten micrometers and be substantially parallel to a top surface of the pillar so that a periphery of the micro-cavity extends beyond a top of the pillar. The substrate cam be a silicon substrate and the pillar can have an isotropic surface. The pillar can also have a tapered shape. A micro-cavity in the form of a disk can be heated so that the diameter of the disk becomes smaller and decreases until the molten disk material collapses, after which the diameter remains substantially constant, thereby forming a toroid micro-cavity.

In method embodiments, an erbium doped sol gel solution is produced by hydrolyzing tetraethoxysilane (TEOS) in water under an acid condition with a co-solvent, such as isopropanol; adding erbium ions, e.g., ErNO₃.5H₂O, to the hydrolyzed tetraethoxysilane, stirring the mixture of the erbium ions and the hydrolyzed tetraethoxysilane at, for example, about 70° C. for about three to ten hours and aging the stirred mixture, thereby forming an erbium doped silica sol gel solution.

The micro-cavity surface can be coated by immersing the micro-cavity in the doped sol gel solution for about 20 minutes and heating the micro-cavity in an oven at about 160° C. for 10 minutes. This results in applying a doped sol gel solution coating having a thickness of about 0.3 μm/cycle, and these steps can be repeated until a desired doped sol gel solution coating thickness is achieved.

### BRIEF DESCRIPTION OF THE DRAWINGS

Referring now to the drawings, in which like reference numbers represent corresponding parts throughout, and in which:

FIG. 1A shows perspective side and top (inset) views of a toroid-shaped micro-cavity that can be coated with a doped sol gel layer or film according to one embodiment;

FIG. 1B is a side view of a toroid-shaped micro-cavity;

FIG. 1C is a top view of a toroid-shaped micro-cavity;

FIG. 2 is a system flow diagram illustrating a method of fabricating a toroid-shaped micro-cavity that can be coated with a doped sol gel layer or film according to one embodiment;

FIG. 3 is a flow chart illustrating more detailed processing steps to produce a toroid-shaped or supported micro-cavity that can be coated with a sol gel layer or film according to one embodiment;

FIG. 4A is a schematic view of a fiber taper coupler or waveguide that is optically coupled to a toroid-shaped micro-cavity that can be coated with a doped sol gel layer or film;

FIG. 4B is a perspective view of a fiber-taper waveguide coupled to a toroid-shaped micro-cavity;

FIG. 4C is a side view of a fiber-taper waveguide coupled to a toroid-shaped micro-cavity;

FIG. 4D is a perspective view of plurality of toroid-shaped micro-cavities coupled to tapered fiber-taper waveguides;

FIG. 5A is a graph illustrating transmission spectra and free spectral range of a toroid-shaped micro-cavity that can be coated with a doped sol gel layer or film,

FIG. 5B is a graph illustrating a ringdown measurement of a toroid-shaped micro-cavity;

FIG. 6 is a flow diagram illustrating a process for making a doped sol gel solution for application to a micro-cavity;

FIG. 7 is a flow diagram illustrating a process for coating a spherical micro-cavity with a doped sol gel layer or film;

FIG. 8 illustrates a microsphere resonator that is coated with a sol gel layer or film and that is optically coupled to a fiber taper;

FIG. 9 shows whispering gallery modes in a coupling zone of a fiber taper and a microsphere resonator that is coated with a doped sol gel layer or film and resulting spherical harmonics;

FIG. 10 shows other whispering gallery modes in a coupling zone of a fiber taper and a microsphere resonator that is coated with a doped sol gel layer or film and resulting spherical harmonics;

FIG. 11 and the inset show a laser spectrum for continuous wave operation of a silica microsphere coated with a doped sol gel layer or film;

FIG. 12 shows the measured pulsation frequency versus square root of laser output power for pulsation mode operation of a silica microsphere coated with a doped sol gel layer or film;

FIG. 13 is a flow diagram illustrating a process of coating toroid shaped micro-cavity with a doped sol gel layer or film;

FIG. 14 illustrates a microtoroid coated with a doped sol gel layer or film and a taper coupling for providing optical pumping and extracting laser optical power;

FIG. 15A is a graph showing an emission spectrum of a doped sol gel functionalized micro-toroid laser (laser output versus wavelength),

FIG. 15B is a graph showing a laser emission spectrum of a doped sol gel coated microtoroid and a reference emission (laser amplitude versus wavelength), and

FIG. 15C is a graph showing measured laser output power versus absorbed pump power.

### DETAILED DESCRIPTION OF ILLUSTRATED EMBODIMENTS

This specification initially describes embodiments of a micro-cavity resonators that are capable of high and ultra-high Q factors, and a method for coating high Q and ultra-high Q micro-cavity resonators with a doped sol gel layer or film. This specification then describes methods for making suitable sol-gel solutions and applying sol gel coatings to surfaces of spherical and toroid or disk shaped micro-cavities in order to functionalize the cavity surfaces. In the following description, reference is made to the accompanying drawings, which show by way of illustration specific embodiments. It is to be understood that other embodiments may be utilized.

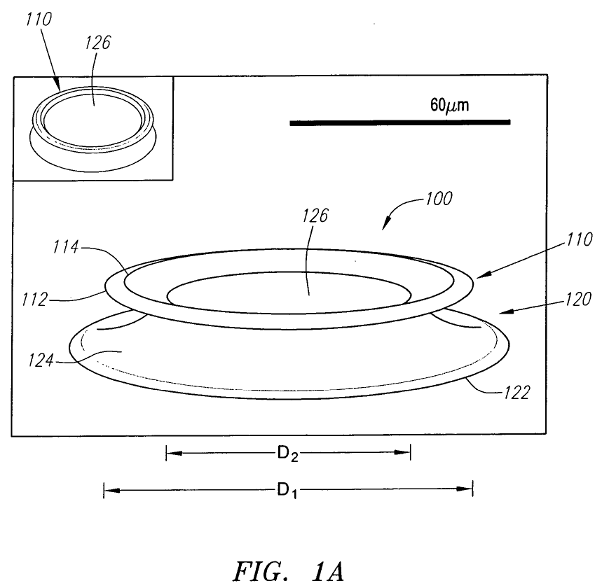

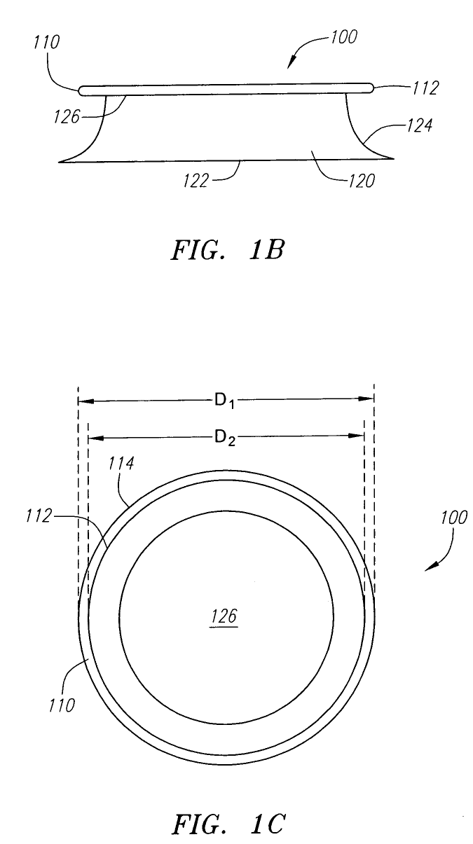

FIGS. 1A-C illustrate an ultra-high Q micro-cavity resonator 100 that includes an optical material or micro-cavity 110 and a substrate 120. In the illustrated embodiment, the micro-cavity 110 is in the form of a ring, disk or toroid has a periphery or outer edge 112 and an inner edge 114. An outer diameter D1 is defined by the outer edges 114, and an inner diameter D2 is defined by the inner edges 112. The micro-cavity can be, for example, a silica micro-cavity. The substrate can be, for example, a silicon substrate.

The substrate 120 includes a bottom surface 122, a middle tapered or angled surface 124, and a top surface 126. Portions of the silicon substrate 120 that are located below the micro-resonator 110, e.g., below a periphery 112 of the micro-resonator 110, are removed so that the substrate 120 is in a form of a support pillar. In the illustrated embodiment, the inner edge 114 of the micro-cavity extends around the outer edge of the top surface 126 of the substrate. Thus, the substrate 120 effectively supports and elevates or suspends the micro-cavity 110 above the bottom surface 122 of the substrate. In the illustrated embodiment, the ultra-high Q micro-cavity 110 is substantially parallel to a top surface 126 of the pillar. Other non-parallel orientations may also be utilized.

Optical energy travels along an inner surface of the outer edge or periphery 112 of the cavity 110, for example, within a whispering gallery mode (WGM) or other resonant modes as needed. A WGM is a resonant mode in which optical energy electromagnetic waves are totally internally reflected, and focused by the inner surface of the micro-cavity. Thus, the optical energy can circulate within the micro-cavity and be confined therein to provide high and ultra-high Q factors.

Various factors can influence the Q factor of the micro-cavity resonator. For example, different optical materials and surface finishes can support different Q factors. Q factors can also change based upon the diameter of the micro-cavity. For example, in one embodiment, the diameter of a silica micro-cavity can be from about 10 μm to about 500 μm, preferably between 25 μm to about 200 μm and the corresponding Q factors can range from about 10⁴ to about 10⁹. In one embodiment, the ultra-high Q micro-cavity has a diameter of at least about 10 micrometers, e.g., between about 10 and about 30 micrometers, and a Q factor of about 500 million. Accordingly, persons of ordinary skill in the art will recognize that the size of the micro-cavity is one factor affecting Q factor, and that various resonators can support optical energy at various Q factors including “high” Q factors and even higher Q factors, such as “ultra-high” Q factors. Persons of ordinary skill in the art will also recognize that resonator embodiments are capable of achieving various ultra-high Q factors, e.g., at least 10⁶ or one million. For example, in one embodiment, the Q factor may be about 10⁸ or 100 million to about 5×10⁸ or 500 million. Further, persons of ordinary skill in the art will recognize that micro-cavities having different shapes and sizes can have various ultra-high Q factors.

The micro-cavity 110 is capable of providing both high and ultra-high Q factors. With respect to micro-cavity 110, this specification primarily refers to an ultra-high Q micro-cavity since micro-cavities having ultra-high Q factors are generally preferred and may be utilized a broader range of applications. Indeed, doped sol gel coatings can be applied to resonators of different shapes that have high or ultra-high Q factors for high and ultra high Q experiments, applications and components.

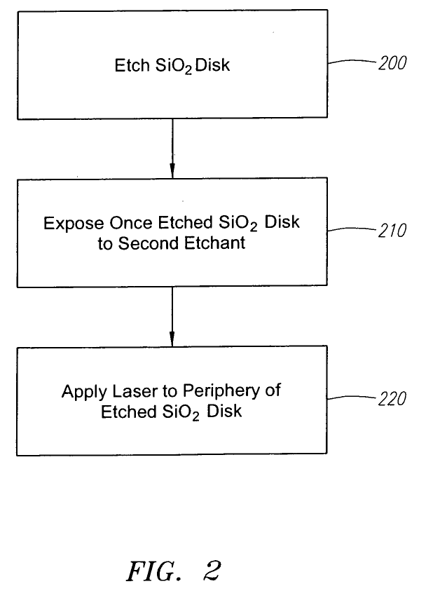

FIG. 2 illustrates a method of fabricating an ultra-high Q micro-cavity that can be coated with a doped sol gel layer or film in order to functionalize the cavity surface according to one embodiment. Initially, in step 200, a silicon dioxide (SiO₂) or silica disk or circular pad is etched, for example, with a buffered hydrogen fluoride (HF) solution. In step 210, the silica disk is exposed to a second etchant, such as xenon difluoride (XeF₂) gas, which removes portions of the silicon base beneath the periphery of the silica disk. Xenon difluoride is an etchant with high selectivity that is currently utilized to produce, for example, Micro Electrical Mechanical Systems (MEMS) devices. In step 220, a laser, such as an Excimer or CO₂ laser, is applied to the undercut periphery of the silica disk. As a result of the laser illumination, the periphery portions of the silica disk are melted or partially or completely liquefied, and a toroid-shaped micro-cavity is formed, as shown in FIGS. 1A-C. It is believed that the molten silica collapses and adheres to itself due to the surface tension of silica.

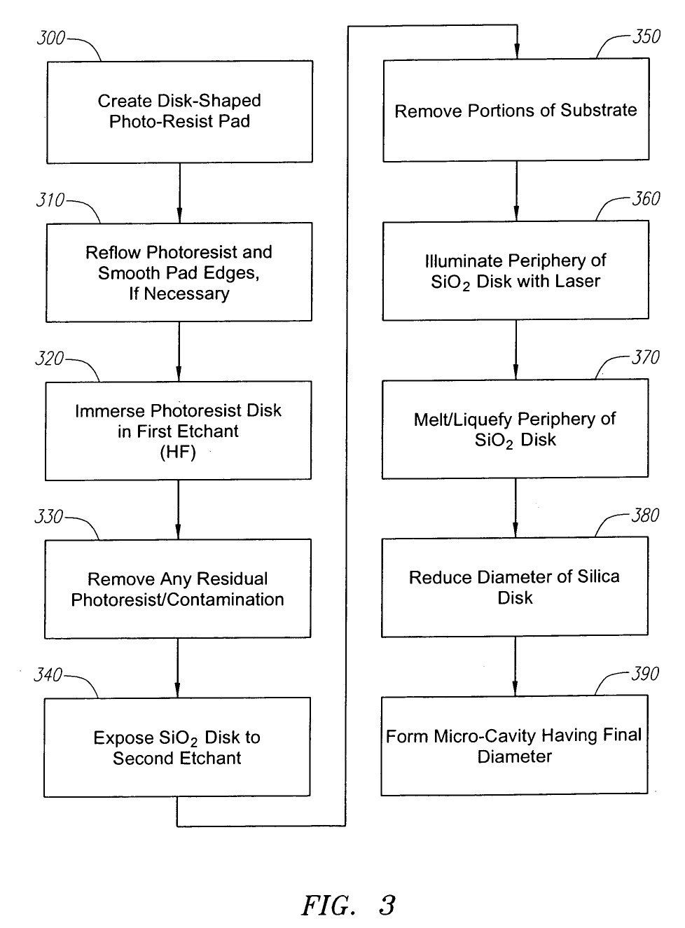

FIG. 3 illustrates further details of method of fabricating a micro-cavity that can be coated with a sol gel layer. An ultra-high Q silica micro-cavity is fabricated on a silicon substrate or wafer, preferably (100) prime grade silicon. The silicon substrate includes a thermal oxide layer having a thickness of, for example, about two micrometers or other suitable thicknesses as needed on the (100) prime grade silicon.

Persons of ordinary skill in the art will recognize that other substrates can also be used depending on the etchants utilized and the particular application. In step 300, known photolithography processing is used to create a disk-shaped photo-resist pad on the thermal oxide layer. The circular photo-resist pad can have a diameter of from about 10 μm to about 500 μm, preferably about 20 μm to about 200 μm, even more preferably about 100 μm.

The photoresist can be heated again in step 310, if necessary, to reflow the photoresist and smooth the edges of the disk. In step 320, the silicon wafer is immersed in a first etchant, e.g., a buffered hydrogen fluoride (HF) etch solution at room temperature. The disk-shaped photo-resist pad acts as an etch mask when immersed in the buffered HF solution. In step 330, residual photoresist and any organic contamination can be removed with acetone or another suitable removal agent.

Continuing with step 340, the silicon wafer is exposed to a second etchant, e.g., xenon difluoride (XeF₂) gas at a pressure of about 3 Torr. The remaining silica disk acts as an etch mask during exposure to the XeF₂ gas. As a result, in step 350, portions of the silicon substrate are removed by the XeF₂ gas, and the remaining portions of the silicon substrate form a pillar, which supports the larger silica disk above. The etchant used in step 340 is preferably a XeF₂ gas since it can selectively remove silicon. Specifically, the XeF₂ gas isotropically removes silicon so that the periphery of the silica disk is equally undercut, leaving a tapered silicon pillar or substrate that supports the larger silica disk. Thus, the outer edges of the silica disk extend around the outer portion of the top surface of the silicon pillar. Removing the higher index silicon from the silicon substrate below a portion of the silica disk periphery also serves to inhibit power leakage from the micro-resonator into the silicon substrate.

At this point, whispering gallery modes (WGMs) can exist along the rim of the silica disk structure. For example, at this stage the disk can have Q factors exceeding 260,000 and can reach levels of about 3.4 million. Q factors of this magnitude within a resonant planar structure prepared on a silicon substrate may already surpass Q factors of conventional planar resonators that are fabricated on the silicon substrates. The surface finish of the disk, however, can be processed further to provide a smoother surface finish that can support substantially higher Q factors, e.g., ultra-high Q factors. Specifically, the periphery of the silica disk can be melted and formed into a low loss, smooth surface, as described in the following steps 360-390.

In step 360, the periphery of the undercut silica disk is illuminated with a laser or other suitable radiation or heat source, such as a CO₂ laser that emits radiation at about 10.6 micrometers. The intensity profile of the CO₂ beam preferably follows an approximate Gaussian distribution and is focused to a diameter of approximately 200 microns. These CO₂ lasers are similar to lasers that are currently utilized in known before processing integrated circuit (IC) planarization. The intensity profile of the CO₂ beam preferably follows an approximate Gaussian distribution and is focused to a diameter of approximately 200 microns.

When the outer portions of the disk are sufficiently heated, in step 370, they melt or are partially or completely liquefied. The silica disk periphery melts due to the temperature dependence of the silica near the 10.6 micrometer laser wavelength and the thermal isolation of the undercut silica disk. As a result of the high surface tension of the silica, the molten silica overcomes the forces of gravity and adheres to itself so that the laser selectively reflows the undercut periphery of the silica disk. During the silica reflow, the CO₂ laser beam intensity can be varied as needed, but is typically about 100 MW/m².

In step 380, as the molten silica disk is heated with the laser, the diameter of the disk structure becomes smaller which, in turn, reduces the effective cross-section of the disk that is available to absorb power from the laser. As a result of the preceding steps, the molten silica shrinks and stabilizes into a toroid-like silica micro-cavity. The time required for the molten silica to assume the toroid-like shape can vary depending on, for example, the size of the disk and the amount and duration of laser radiation. For example, in one embodiment, the disk shrinks into the terminal toroid shape having a final diameter after laser radiation. Different durations of laser heating may be utilized depending on the particular materials and micro-cavity applications, e.g., about 1 microsecond to about 10 seconds of laser heating may be utilized. During laser heating, the silicon pillar remains significantly cooler and physically unaffected throughout the silica reflow process, serving as a heat sink to selectively absorb and dissipate heat generated by the reflow process. This is due to silicon having a weaker optical absorption than silica at 10.6 microns. Silicon is also about 100 times more thermally conductive than silica.

The initial diameter of the silica disk can be, for example, from about 20 μm to about 1000 μm. The final or terminal outer diameter of the micro-cavity can be, for example, from about 10 μm to about 500 μm, preferably about 100 μm. The micro-cavity can have a thickness of about 1 μm to about 12 μm, preferably 4 μm. The final diameter of size of the micro-cavity can be limited by the size of the top surface of the silicon substrate. In other words, when needed the molten silica disk shrinks and collapses upon itself until the inner surface of the disk shrinks around the outer portion of the top surface of the silicon pillar. Thus, the micro-cavity is “self-quenching” when heated and assumes the shape of a toroid as a stable state. The final diameter of the micro-cavity can also be further controlled by additional lithography and chemical etch steps, as needed.

The resulting toroid-shaped micro-cavity has smoother surfaces with an improved surface finish compared to the silica disk before the laser reflow processing. For example, after the reflow processing, the toroid-shaped micro-cavity can have Q factors exceeding one million (ultra-high Q factors), whereas the Q factor of the silica disk before the laser reflow processing was about 260,000 in this particular example.

The surface finish of the toroid-shaped micro-cavity has a root mean square (rms) roughness of about several nanometers. These surface finishes are similar to surface finishes of micro-sphere resonators, but are provided in a planar micro-resonator that can be prepared on a silicon substrate using known wafer processing and component integrating techniques. Other characteristics and technical aspects of a toroid-shaped micro-cavity and methods for making the same are described in “Ultra-High-Q Toroid Micro-cavity on a Chip,” Nature, vol. 421, no. 6926, pp. 925-928 (Feb. 27, 2003), the disclosure of which is incorporated herein by reference and U.S. Application No. 10,678,354, filed Oct. 2, 2003 entitled “Ultra-High Q Micro-Resonator and Method of Fabrication, previously incorporated by reference.

Having described embodiments of a microtoroid resonator that can have high or ultra-high Q factors and one manner of manufacturing such micro-resonators utilizing laser radiation to reflow of periphery of a silica disk, persons of ordinary skill in the art will recognize that various modifications to the previously described micro-resonator and fabrication method can be implemented to fabricate other micro-resonators capable of ultra-high Q factors.

For example, other optical materials can be utilized to produce an ultra-high Q micro-resonator. In an alternative embodiment, the optical material may be a low melting point glass that has a melting point that is lower than silica, which has a melting point of about 1983° F.+-100° F. Laser radiation can be applied to the low melting point glass to reflow the glass to form the micro-cavity. Further, both the low melting point glass and the substrate (e.g. silicon substrate) can be heated together without the use of a laser. In this embodiment, the temperature is controlled so that the glass melts before the silicon substrate. As a result, the silicon substrates maintains its integrity, and the low melting point glass is melted into the ultra-high Q micro-cavity and can assume a toroid shape, as previously discussed. Further, other suitable materials besides silica and low melting point glass can be utilized if they possess a relatively high surface adhesion that can overcome forces of gravity. In addition, other substrates besides a silicon substrate can be utilized, such as III-V substrates.

In the illustrated embodiment, the micro-cavity 110 has a generally circular or disk shape. For example, the micro-cavity shown in FIGS. 1A-C has a toroid or doughnut-like shape. Toroid dimensions may vary with the size of the micro-cavity. In one embodiment, the toroid has a thickness of about 0.5 to about ten μm. Upon reading this specification, persons of ordinary skill in the art will recognize that micro-cavity resonators can have other shapes besides a disk or toroid-like shapes including, but not limited to, an elliptical shape, an oval or “race track” shape, partially toroid, elliptical, oval and circular shapes, and various other irregular shapes by utilizing different materials, etchants, heating/reflow temperatures, durations. This specification, however, refers to and illustrates a toroid-shaped micro-cavity for purposes of explanation and illustration.

Further, different radiation sources and lasers that emit radiation at different emission wavelengths may be suitable for other optical materials including, but not limited to, Excimer lasers. Further, the laser can be applied to different portions of the periphery of the silica disk for different periods of time and patterns for various degrees of reflow or to produce micro-cavities of different shapes. For example, as previously discussed, the laser can be applied to the silica disk so that it reflows and adheres to itself and consistently shrinks to its terminal diameter. The laser, however, can also be applied to the silica disk for smaller amounts of time. In these instances, the diameter of the silica micro-resonator would be smaller than the initial diameter, but larger than the terminal diameter. In yet a further alternative embodiment, once heating of the silica disk has begun, the reflow process can be interrupted prior to quenching of the silica disk and forming a toroid shape. In this instance, the micro-resonator would also have larger diameter than the terminal toroid diameter.

The laser or other heat source can also be applied to selected sections of the silica disk for different amounts of time to produce micro-resonators with different shapes and sizes. As a result, only the heated sections may become smaller, thereby resulting in an elliptical or irregularly shaped micro-cavities. Accordingly, the toroid shape having a terminal diameter is merely illustrative of a preferred ultra-high Q micro-cavity. The invention, however, is not so limited.

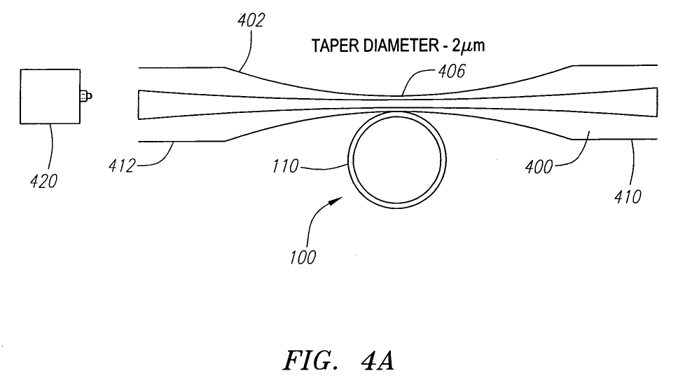

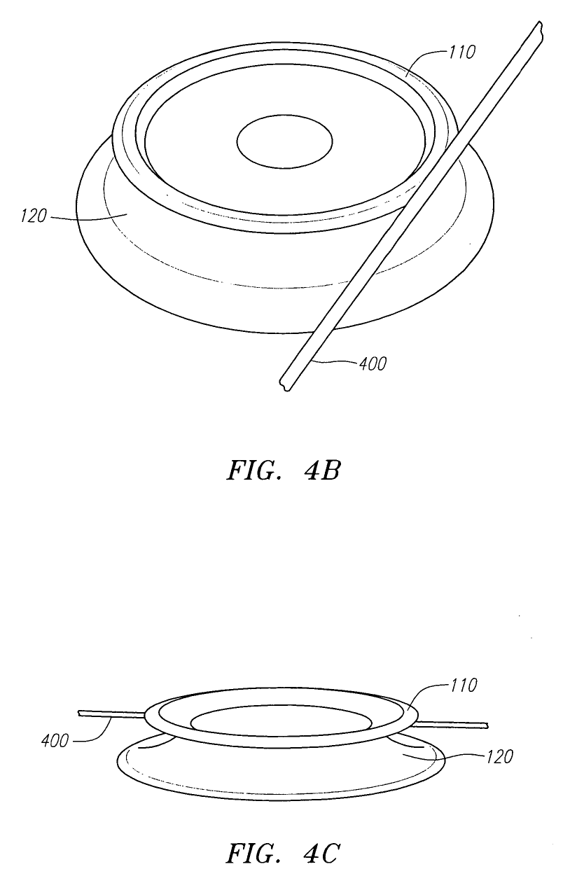

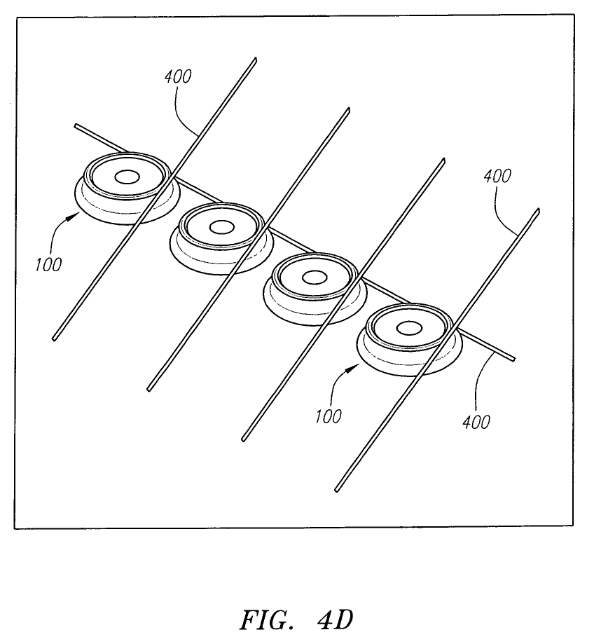

One manner in which light stored in an ultra-high Q micro-cavity resonator is coupled to a transmission media, waveguide or coupler is illustrated in FIGS. 4A-D, transmission media 400 is utilized to carry optical energy stored in the micro-cavity. Active media, which are excited by optical pumps can also be associated with the micro-cavities to facilitate the lasing of a signal within a frequency band of interest. In one embodiment, the transmission media 400 is a fiber waveguide, preferably a tapered waveguide as shown in FIG. 4A, although other fiber configurations can also be utilized.

The tapered sections 402 and 404 and the intermediate waist region 406 of the waveguide 400 may be provided, as is known, by stretching a fiber (e.g., a single mode fiber) under controllable tension as it is softened by one or more fixed or movable heat sources (e.g., torches). The ultra-high Q micro-cavity 100 is coupled to the externally guided power about the waist region 406 of the fiber 400. Commercially available machines can be used for this purpose in production environments. Taper waist 406 diameters are typically several microns, preferably about two microns. The diameter of the waist region can be adjusted to properly phase-match to the ultra-high Q micro-cavity resonator. Other discussions and details of such taper couplings can be found in U.S. Pat. No. 6,633,696, entitled “Resonant Optical Wave Power Controlled Devices and Methods,” the disclosure of which is incorporated by reference herein.

The consequent reduction in diameter of about one or more orders of magnitude reduces the central core in the core/cladding structure of the optical fiber to vestigial size and function. As a result, the core no longer propagates a majority of the wave energy. Instead, without significant loss, the wave power in the full diameter fiber transitions into the waist region, where power is confined both within the attenuated cladding material and within a field emanating into the surrounding environment. After propagating through the waist region 406, exterior wave power is recaptured in the diverging tapered region and is again propagated with low loss within the outgoing fiber section 410.

An optical pump 420 is optically connected to a first end 412 of the fiber. The optical pump 420 transmits a signal along the waveguide and to the ultra-high Q micro-cavity resonator through the fiber taper. One or more excited laser signals in the ultra-high Q micro-cavity resonator are then communicated to the fiber waveguide. The resonator re-circulates the energy with low loss in, for example, a WGM, or other resonant mode, returning a part of the power to the waveguide at the waist. When a resonance exists at the chosen wavelength, the ultra-high Q micro-cavity functions with effectively total internal reflection and with minimal internal attenuation and radiative losses. However, the emanating portion of the wave power is still confined and guided, so it is presented for coupling back into the waveguide waist. These fiber coupling techniques can be used to couple a single tapered fiber to a single ultra-high Q micro-resonator, as shown in FIGS. 4B and 4C. Alternatively, a plurality of tapered fibers can be coupled to a plurality of micro-resonators, for example, as part of a circuit or to integrate with other components, as shown in FIG. 4D.

In one study, the mode structure and Q factor of toroid-shaped micro-cavities were characterized in an optical telecommunication band (1500 nm band). Tapered optical fibers (as previously discussed) were coupled to a single-mode, tunable, external-cavity laser to efficiently excite whispering gallery modes of the ultra-high Q micro-cavities. Tapered waveguides were positioned on a 20 nm resolution stage and could be moved freely over the sample to individually couple to each of the toroid-shaped micro-resonators. Dual microscopes were used to simultaneously image the micro-cavities and fiber tapers from the side and the top. In order to achieve proper alignment, the taper axis was adjusted to reside in the equatorial plane of the toroidal micro-cavity with minimal tilt angle. Critical coupling or the resonant transfer of all optical waveguide power into the resonator, was achieved by adjusting the gap between the taper and the micro-cavity. Low non-resonant losses were observed (e.g., <5%).

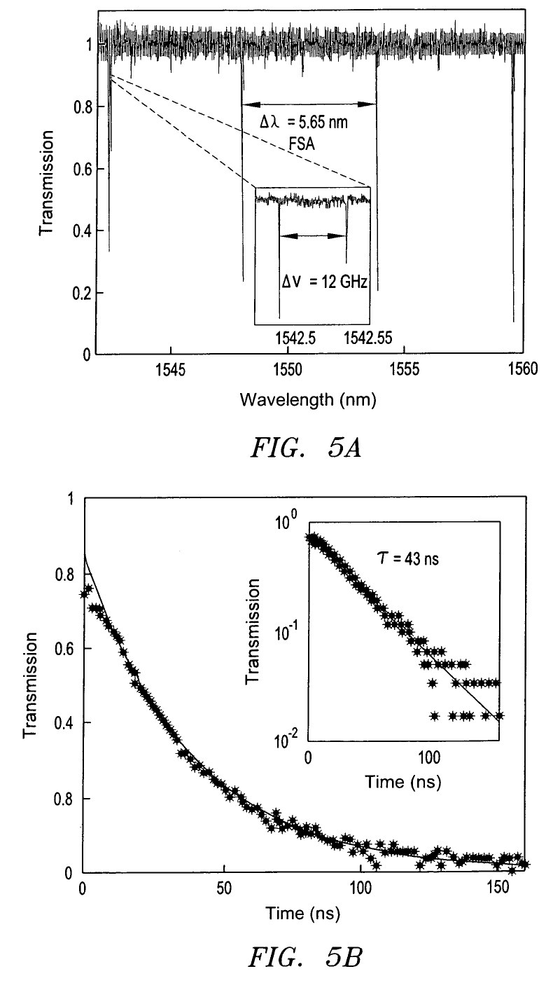

FIGS. 5A and 5B illustrate graphs showing optical characteristics of two ultra-high Q micro-cavities according to the present invention. FIG. 5A shows the transmission spectra through a taper in close proximity (on the order of hundreds of nanometers) to a 94 μm diameter toroidal micro-cavity according to the present invention. The observed free spectral range (FSR) corresponds to the equatorial mode number (1-index, which in this case is >270). The micro-cavity having a FSR of about 1 nm to about 100 nm. As shown in the inset of FIG. 5A, the micro-cavity also supports at least two azimuthal (m-index or transverse) modes. The micro-cavity can also be configured to have differential azimuthal modes of about 12 GHz. Alternatively, the micro-cavity can be configured to have a single radially and transversely supported mode.

The Q factor of the micro-cavities was measured in two ways. First, the full-width half-maximum of the Lorentzian-shaped resonance in the undercoupled regime was directly measured by scanning a single-mode laser (short-term linewidth about 300 kHz) through a resonance. Low input power levels (typically less than 5 microwatts) were used to avoid thermally-induced distortion of the line shape due to resonant-field buildup within the cavity. Repeated measurements on samples fabricated with various radii (80-120 micron) and tori thickness (5-10 micron) yielded Q factors in excess of 100 million (10⁸), whereas previous known planar micro-resonators fabricated by wafer-scale processing typically have Q factors as much as four orders of magnitude lower.

Referring to FIG. 5B, data from a typical ringdown measurement is provided for a micro-cavity according to the present invention having a diameter of about 90 μm. As an independent and more precise measurement of the Q factor, the photon lifetime was directly measured by cavity ringdown. In particular, ringdown measurements are immune to the thermal effects described above. This was done by repeatedly scanning the laser into resonance with a mode that was critically coupled to the taper. As the laser scanned into resonance, power transfer increased until maximal “charging” of the resonant mode was attained. At this moment, the laser input was gated “off” by use of a high-speed, external modulator and cavity ringdown is observed as the resonant power discharges. Because the micro-cavity is by necessity loaded during this measurement, the observed ringdown time yields the loaded Q-factor at the critical point (not the intrinsic Q).

At time t=0 in FIG. 5B, a signal is applied to “gate” the laser off. When the laser input is fully off, the detected power is due entirely to the cavity discharge field. The solid line represents an exponential fit as expected for decay of a single cavity mode. The inset shows a logarithmic plot to infer the cavity lifetime. The loaded lifetime in this structure was 43 ns. As a further check on this time constant, after gating of the pump laser the waveguide power has dropped to 80% of its predicted maximal value based on extrapolation of data to t=0. This value is consistent with the gating delay of the ringdown setup (approximately 8 ns). In particular, using the observed mode-lifetime of τ=43 ns yields e^{-ΔT/τ}≈0.83.

Loading by the taper waveguide and the excitation of the counter-propagating mode due to scattering centers intrinsic to the resonator (described by a dimensionless intermode coupling parameter Γ) are accounted for when inferring the intrinsic cavity Q factor. The techniques used to measure this parameter in ultra-high-Q taper-coupled resonators are described in various references.

For the mode shown in FIG. 5B, the intermode coupling was measured to be approximately 1, giving rise to a weak counter-propagating wave excitation (17% of the cavity buildup field is stored in the counter-propagating mode at critical coupling). In the presence of intermode coupling the relationship between the critically-coupled and the intrinsic (unloaded) cavity Q becomes, Q₀=ωτ₀=ωτ_{crit} (1+\sqrt{1+Γ²}). This yields an intrinsic cavity Q of 1.25×10⁸ inferred from cavity ringdown. This value is consistent with the measurements of the frequency line shape described above.

In yet a further alternative embodiment, the silica ring can have a treated surface (such as a biotinlynated surface), a dopant or an embedded active optical component that may alter or functionalize the operation of an ultra-high Q micro-cavity resonator. For example, in one embodiment, the silica ring is doped with erbium. In a further alternative embodiment, the silica ring includes an embedded active component, such as erbium. Persons of ordinary skill in the art will recognize that other dopants and components can be utilized depending on the desired micro-cavity characteristics and functions. The ultra-high Q micro-cavity can also include a coating, such as a chemical or biologically active substance, to functionalize the micro-cavity surface. Having discussed various attributes of high and ultra high Q micro-resonators, this specification now describes in further detail how these resonators can be coated with a doped sol gel film or layer in order to functionalize the resonator surfaces. For example, a coating or dopant therein can alter the wavelength of an uncoated resonator so that the coated resonator emits optical energy at a different wavelength, e.g., a wavelength that is more useful than the original wavelength, such as a wavelength typically used in telecommunications applications.

In one embodiment, a micro-cavity is coated with a doped sol-gel film, such as an erbium-doped sol-gel film. Sol-gel is a colloidal suspension of silica particles that is gelled to form a solid. Various commercially available sol-gel films can be used with embodiments including sol gel films having, for example Arsenic, Boron and Phosphorous, which are available from Honeywell Electronic Materials, Star Center West, 1349 Moffett Park Drive, Sunnyvale, Calif. The Er⁺³ concentration in the sol-gel layer can be from about 10¹⁹ to 10²² cm⁻³, preferably about 10¹⁹ cm³.

A sol gel coating or layer can be applied to micro-cavities of various shapes, including spherical microcavities or toroid-shaped micro-cavities. Details regarding applying a doped sol gel coating or layer to a spherical micro-cavity are described in “Gain Functionalization of Silica Micro-resonators,” Optics Letters, vol. 28, no. 8, pp. 592-594 (Apr. 15, 2003), the disclosure of which is incorporated herein by reference. Details regarding applying a doped sol gel coating or layer to a toroid-shaped micro-cavity resonator are described in “Fiber-coupled Erbium Microlasers on a Chip,” Applied Physics Letters, Vol. 83, Number 5, p. 825 (Aug. 4, 2003), the disclosure of which is incorporated herein by reference. This specification describes manners of making suitable sol gel materials, applying sol gel coatings to spherical and toroid-shaped micro-resonators, and attributes of spherical and toroid-shaped micro-resonators that are coated with doped sol gel films or layers, as discussed in the incorporated Apr. 15, 2003 and Aug. 4, 2003 articles.

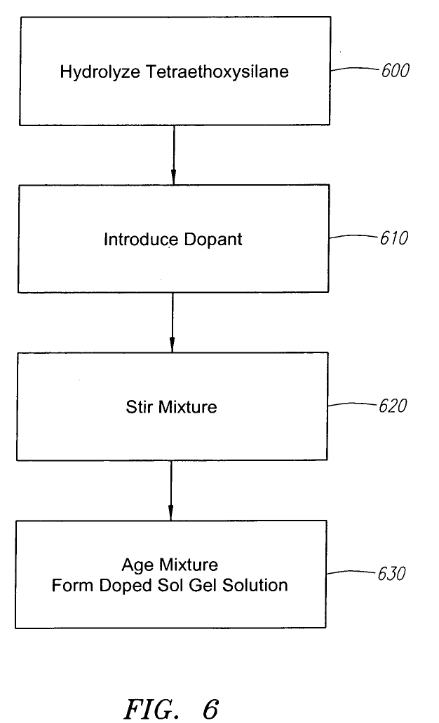

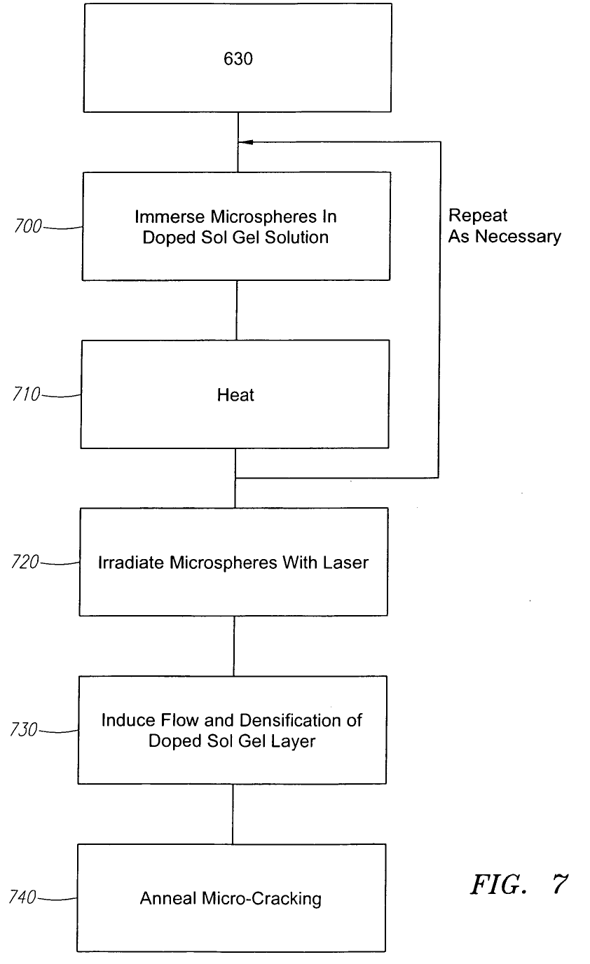

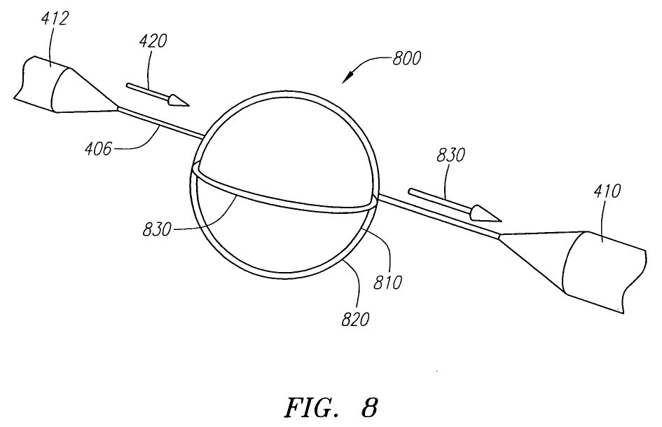

FIG. 6 generally illustrates a method for making a suitable doped sol gel solution. In step 600, tetraethoxysilane (TEOS) is hydrolyzed in water under acid conditions (pH˜1) with isopropanol as a co-solvent. TEOS is commercially available from Alfa Aesar, 26 Parkridge Road, Ward Hill, Mass. In step 610, a dopant is introduced into the hydrolyzed TEOS. In one embodiment, the dopant includes erbium ions. Erbium ions can be introduced by adding ErNO₃.5H₂O with a weight ratio of ErNO₃.5H₂O/TEOS˜0.2 wt %. Thus, the silica sol gel solution serves as a “host” for the dopant. In step 620, the sol gel/dopant mixture is stirred at 70° C. In step 630, the mixture is aged at room or ambient temperature for about three to ten hours to form a doped silica sol gel solution, in this embodiment, an erbium doped sol gel solution.

Other dopants and combinations of dopants may also be utilized. For example, in alternative embodiments, the dopant can be other rare earth element such as yttrium, neodymium, or combinations thereof. Other suitable dopants may include nanocrystals and organic materials. Thus, the sol gel host can be used with many different doping applications.

As disclosed in the incorporated Apr. 15, 2003 article, initial pure-silica microspheres can be produced by heating an end of a tapered fiber with a CO₂ laser. When silica microspheres are doped with any number of rare earth ions, ultra-low threshold micro lasers are possible. In conventional techniques, the preparation of these devices utilizes bulk samples of rare-earth doped glass that are subsequently processed into a spherical cavity. Embodiments utilizing a doped sol gel solution greatly improve upon this conventional method, as discussed below.

After aging a doped sol gel solution at room temperature, in step 700, in one embodiment, silica microspheres are immersed in the solution using a dip coating method. Step 700 can be repeated as necessary. Multiple process cycles or immersions may be required to build up a desired sol gel layer over the microsphere. For example, each process cycle may involve dipping the sphere into the sol gel solution for about 20 minutes (step 700), and heating the microsphere in an oven at 160° C. for 10 minutes (step 710). The thickness of the doped sol gel layer that is obtained in a processing cycle may depend on, for example, the dipping time and solution viscosity. In one embodiment, the sol gel thickness is at least about 0.5 micrometer. For example, a spherical micro-cavity can have a diameter of about 25 to 200 μm, and a thickness of the doped sol gel coating is at least about half micrometer.

In one process, the build-up rate of the doped sol gel solution was estimated to be about 0.3 μm/cycle. This rate was determined by observing the layer thickness after multiple cycles. Every two cycles, the spheres were irradiated using a CO₂ laser for several seconds (step 720).

The laser intensity was sufficient to modify the sol gel material by inducing flow and densifying the doped sol gel layer (step 730). In addition, micro-cracking that was present in the sol gel surface was annealed out by the laser (step 740).

By repeating the immersion and heating steps, the coating thickness was varied. Silica spheres having diameter from 50 to 80 μm were tested, and doped sol gel coatings having a thickness from about 1 to tens of microns were applied to the silica mircospheres. The Er⁺³ doping concentration of the resulting doped shell was estimated to be around 10¹⁹ cm⁻³. In an alternative embodiment, the doped sol gel layer can be applied by using a spin-coating method.

As shown in FIG. 8, microspheres 800 of undoped silica serve as a base resonator structure. In one embodiment, gain functionalization of a surface 810 is performed using an erbium-doped sol gel film 820. In other words, the sol gel film 820 influences or determines a wavelength of the optical output of the microsphere. Optical fiber tapers can be used to couple to the spherical microcavities for pumping 420 and for laser output extraction 830, as previously discussed. Such resonators can be efficiently pumped due to the small gain volume within the sphere. For example, a typical waist diameter of the tapers used to couple pump power and collect laser emission is about 1.6 μm.

Erbium-doped microlasers formed by the doped sol gel coating being applied to a silica spherical micro-cavities according to one embodiment are especially useful. The doped sol gel coating influences or determines the output as falling in the 1.5 micron window that is used for optical communications. These micro-lasers can also have useful Q factors ranging from, for example, about 10⁶ to about 10⁷. Taper coupling has been used to demonstrate such microsphere-lasers in telecommunication bands. Sol gel coated microsphere resonators also provide the ability to excite WGMs. WGM resonances correspond to light trapped in circulating orbits just within the surface of the spheroidal particle. Modal indices are similar to those used to characterize simple atomic systems with radial (n), orbital (l), azimuthal (m) and polarization (TE or TM) indices needed to completely specify a mode.

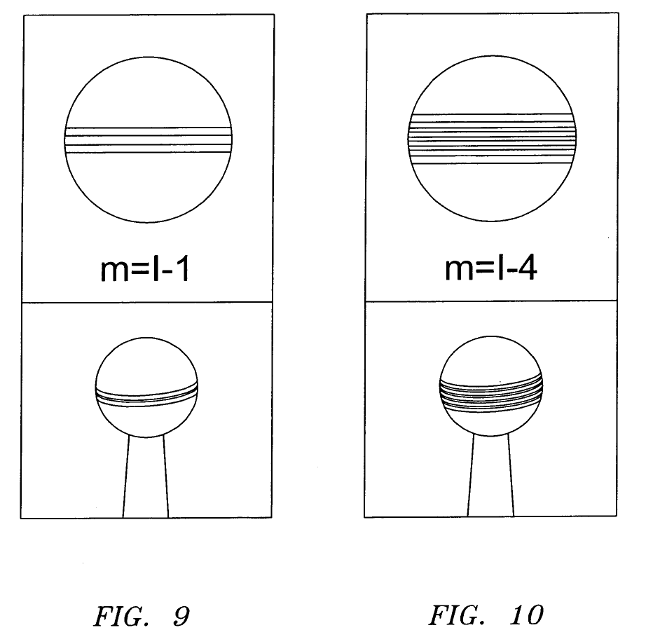

As shown in FIGS. 9 and 10, the angular distribution of the modes is given by the spherical harmonics Yₗₘ(θ,φ) and the WGM modes with best spatial overlap to the fiber taper have their power concentrated near the equatorial plane (m≈1) with a low radial coordinate n≈1. These modes are also best able to pump the active medium surface layer over a radial thickness given approximately by the material wavelength of the pump band. The pumped region will overlap with the emission band modes enabling lasing action. For a surface layer thickness somewhat less than the radial width of the pump mode, nearly complete inversion is expected within annular shaped equatorial bands. When the thickness of the microsphere is substantially greater than the pump-mode radial width there will remain unpumped regions that can provide saturable absorption to the longer-wavelength lasing modes. In addition to modifying the threshold characteristics, saturable absorption is known to modify lasing dynamics such that pulsation behavior is possible. The use of different shell thicknesses is discussed in further detail below.

One suitable pump wave is in the 980 nm wavelength band and is provided by a tunable single frequency, narrow-linewidth (<300 kHz), external-cavity laser. The pump wavelength was scanned initially to survey pumping modes. These were observable by monitoring the transmission versus tuning and also by using a camera to monitor green, excited-state emission from the sphere as the pump laser tuned into resonance with various pump modes. FIGS. 9 and 10 shows representative lateral emission distributions observed for different WGMs in the sphere-taper coupling zones. The pump power coupled to the sphere was measured as the difference of the launch power into the taper and the transmitted power after the taper.

Both continuous wave (CW) operation and pulsation mode (PM) operation can be utilized by controlling the thickness of the doped sol gel coating on the microsphere resonator. For example, CW laser operation can be achieved using doped sol gel coating thicknesses in the range of 1 micron, while PM laser operation can be achieved using doped sol gel coating thicknesses of about or above 5 microns. The thickness of the doped layer was estimated by observing the thickness of the sphere both before and after the coating process.

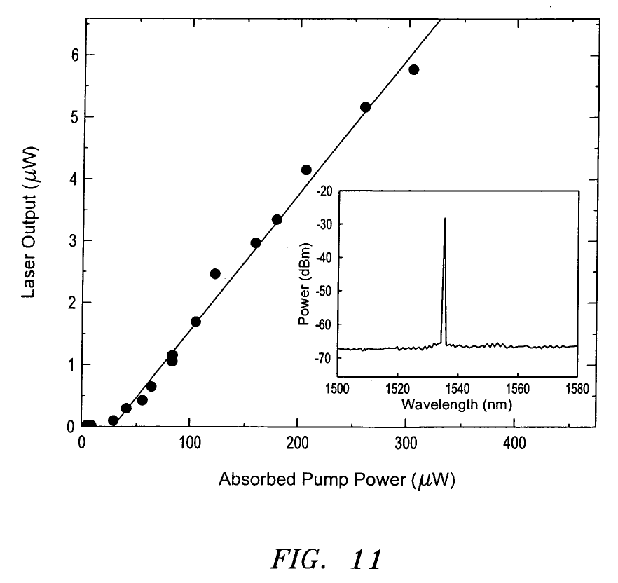

FIG. 11 and the inset therein show a typical laser spectrum for CW operation of a spherical resonator coated with an erbium doped sol gel film or layer according to one embodiment. This spectrum was measured using an optical spectrum analyzer with resolution bandwidth setting of 0.5 nm. Multi-line operation was also observed and depended upon the coupling condition and pump wavelength selected. By tuning the pump wave, however, it was possible to achieve single line operation with proper choice of the coupling condition. This is believed to result from strong spatial mode selection possible when the so-called fundamental WGM (equatorial ring orbit) is resonantly pumped. FIG. 11 shows the laser output versus the pump power absorbed by the microsphere for CW operation. The threshold was estimated to be around 28 μW, and the laser reaches an output power of 6 μW. Above threshold, the laser output power varied linearly with absorbed pump power. A laser output power of up to 10 μW was observed for single-mode PM operation. For convenience during the experiments, the sphere was in contact with the taper (i.e., zero air gap). This greatly restricted control of coupling and potentially limited the optimization of laser output power. In addition, optimal coupling of the pump requires balancing of taper loading with round-trip loss (dominated by erbium absorption in the shell layer). Optimal coupling of laser emission also requires optimization of loading, but not necessarily for the same conditions as for the pump. Other factors affecting coupling are phase matching and field overlap between the taper and sphere modes in both the pump band and the emission band.

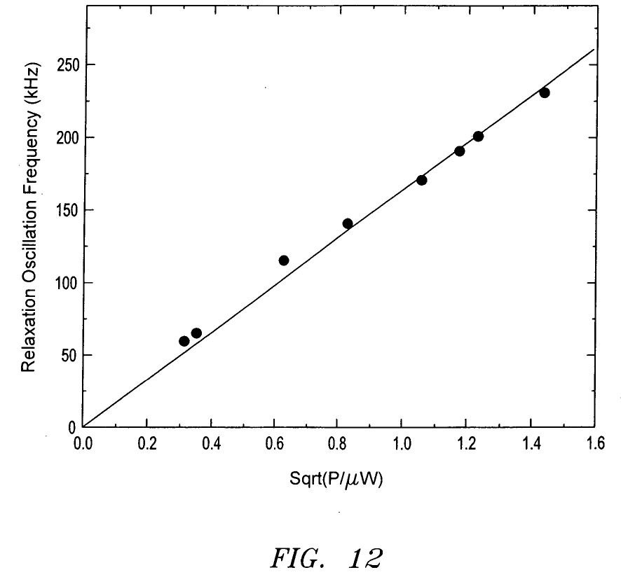

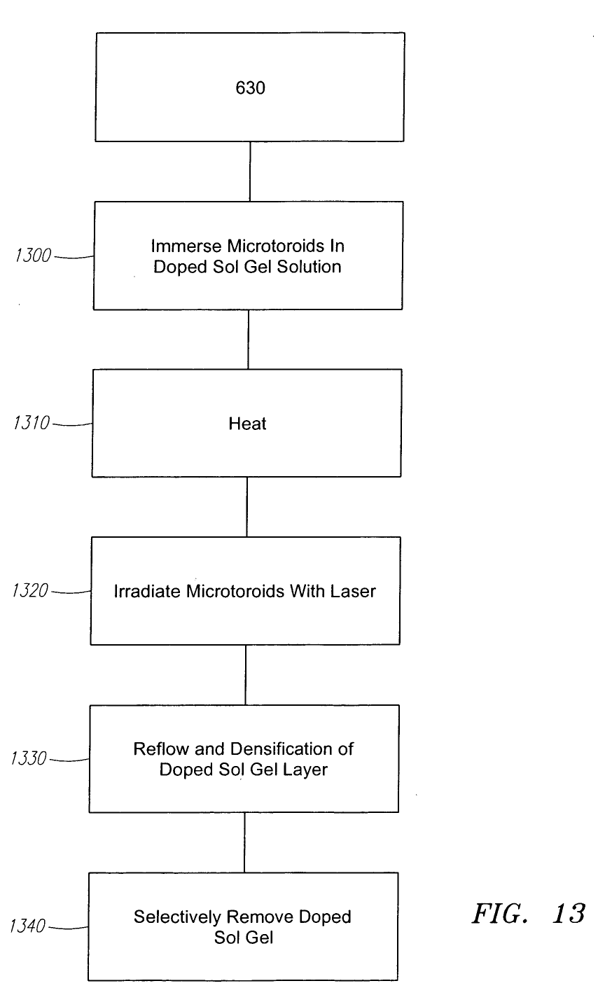

FIG. 12 shows the measured pulsation frequency versus the square root of the laser output power for PM operation of a spherical resonator that is coated with an erbium doped sol gel layer or film according to one embodiment. The pulsation frequency was in a range from tens of kilohertz to several hundred kilohertz. An electrical spectrum analyzer was employed for this measurement. The observed linear behavior is consistent with un-damped relaxation oscillations. The ability to induce PM operation by control of the sol gel shell thickness is attributed to unpumped inner regions of the shell that can provide saturable absorption to the lasing mode. This is consistent with the observation of PM operation in prior microsphere laser work using bulk-doped glass for sphere fabrication. Azimuthal surface regions can also potentially provide saturable absorption.

Gain functionalization of silica microspheres using doped sol gel films provides a way to achieve a range of possible gain media in the microsphere system so that the resonator can achieve desired Q factors and be used at various wavelengths with various components and applications. For example, such microlasers are useful with applications involving 1.5 micron optical communications, as previously discussed. Other possible surface layers that target applications, such as nonlinear optics in a micro-cavity, may also benefit from such doped sol gel coatings and techniques. The sol gel gain layer also provides the ability to quench previously observed pulsations in these devices, thereby achieving CW laser operation. For shell thickness in the range of 1 micron, CW laser operation was observed. This behavior as well as the onset of pulsations for thicker active shells is attributed to unpumped and hence saturable absorbing regions that can be present in thick shells.

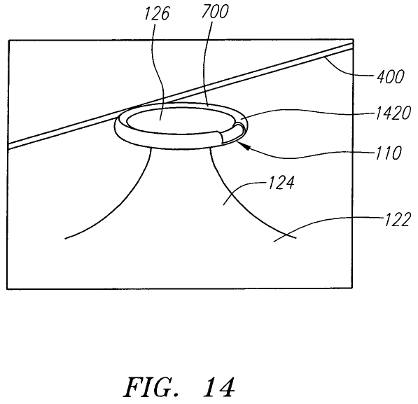

Referring to FIGS. 13 and 14, in addition to applying doped sol gel layers to spherical resonators, in another embodiment, doped sol gel layers are applied to toroid or disk shaped micro-cavity resonators 100, as discussed in detail in the Aug. 4, 2003 article, previously incorporated herein by reference. Doped sol-gel films 1420 are applied to the surface 110 of a silica toroidal micro-resonator to create micro-cavity lasers that provide for highly-confined WGMs to allow single-mode and ultralow threshold microlasers. In one embodiment, the doped sol gel solution 1420 is an erbium doped sol gel solution.

In this embodiment, the surface of toroid-shaped structures is coated and functionalized to provide for wafer-based rare-earth doped microlasers. These devices are integrable with other optical or electric components and are directly coupled to optical fiber using fiber tapers 400. Erbium-doped microlasers are especially useful since their emission band falls in the 1.5 micron window used for optical communications. Further, the planar structure of such microlasers allows them to be integral with other planar components, including known silicon-based electronic and optical components.

Referring to FIGS. 13 and 14, after aging the doped sol-gel solution at room temperature for about 10 hours, silica microtoroid resonators are immersed in the solution for about three to five hours (step 1300). The wafers are heated in an oven at 160° C. for about two to ten hours to drive off surface water (step 1310). The micro-toroids are then irradiated with a CO₂ laser (10.6 μm emission) to reflow and densify the doped sol-gel films (step 1320). As previously discussed, CO₂-laser emission is selectively absorbed by the silica layers. This and the relatively high thermal conductivity of silicon (˜100 times more thermally conductive than silica) leads to selective reflow and densification of doped sol-gel 1420 at the toroid periphery (step 1330).

Thus, as shown in FIG. 14, doped sol gel 1420 deposited on all regions of the wafer other than the densified perimeter of the toroid were subsequently selectively removed. Persons of ordinary skill in the art will appreciate that it is preferred to coat the exemplary micro-toroids having diameters ranging from 60 to 85 μm, an Er+³ concentration in the sol-gel layer of about 10¹⁹ cm⁻³, and Q factors of about 106 to about 10⁷. Sol-gel deposited elsewhere may be unaffected by the laser. Because of the difference between the etching rate of densified and undensified silica films in buffered HF, doped sol-gel deposited on all regions of the wafer other than the densified perimeter of the toroid can be subsequently selectively removed (step 1340). Thus, a sol gel coating 1420 can be applied to the entire perimeter of the toroid. FIG. 14 is a cut-away view that illustrates the doped sol gel 1420 applied to the toroid perimeter.

The microtoroids have optical modes that are confined near the resonator periphery. As previously discussed, the thickness of the microtoroid is generally smaller than the microtoroid diameter. Thus, toroid resonator structures support fewer azimuthal modes and facilitate single-mode operation. The gain functionalization of the surface places the optical gain only where it is most useful, i.e., where best overlap is possible with the fundamental whispering gallery modes.

For example, FIG. 14 illustrates both a sol-gel functionalized microtoroid and the taper coupling 400 configuration used to both provide optical pumping and to extract laser optical power. The pump wave was provided by a tunable, single-frequency, external-cavity laser operating in the 980 nm band and having a short-term linewidth less than 300 kHz. The sample chip was held in a rotator that was mounted upon a 3-axis translator for position control. Two CCD cameras were used to monitor the microtoroid samples and the taper, providing both horizontal and vertical views. The angle of the microtoroid relative to the taper was adjusted using the rotator to align the taper with the equatorial plane of the toroid.

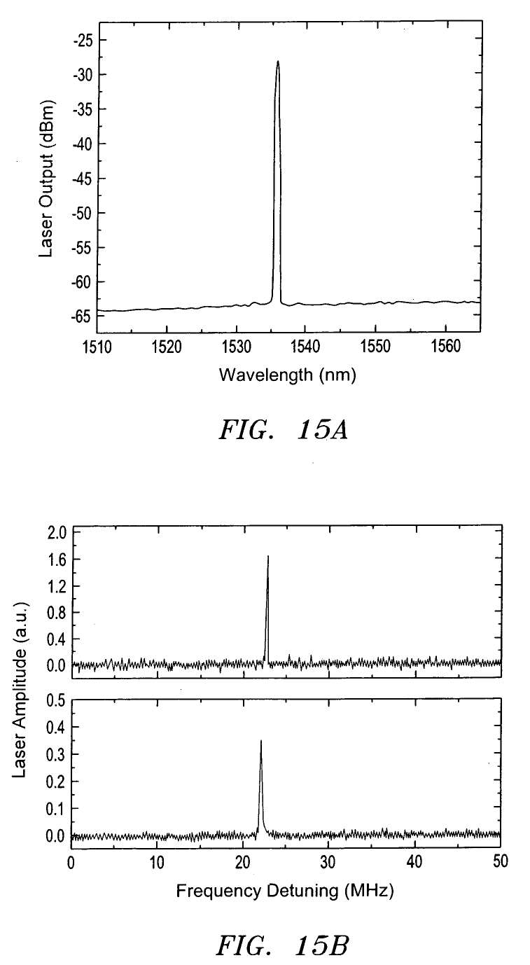

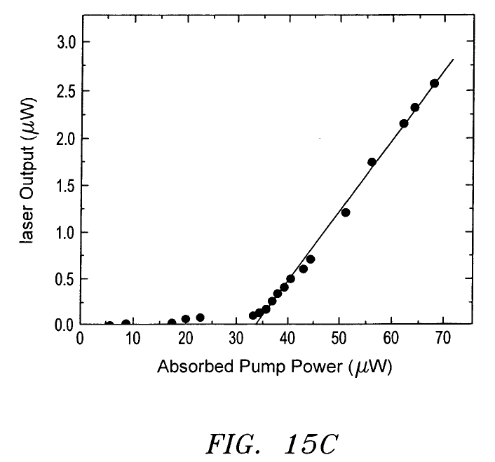

An optical spectrum analyzer (OSA) with resolution of 0.5 nm was used to measure the laser emission. A typical laser spectrum is presented in FIG. 14A. Single line emission (within the resolution of the OSA) was most often observed, however, at increased pumping levels it was sometimes possible to induce oscillation in other longitudinal modes. To further resolve the single line observed in the OSA scan of FIG. 15A, a high finesse (˜5000) Fabry-Perot etalon having a resolution of a few megahertz was also used to analyze the laser spectrum. A single-frequency, tunable, external-cavity laser emitting in the 1500 nm band and with known short-term linewidth of 300 kHz was measured as a reference. Both spectra are presented in FIG. 15B.

The measured laser output power plotted versus the absorbed pump power is shown in FIG. 15C. The threshold pump power in this data is 34 μW by extrapolation of the linear lasing region. The differential quantum efficiency was measured to be as high as 11% for the single-model operation. During measurements, the microtoroids were in contact with the taper. While this creates a very stable coupling, it prevents optimization of the pump and emission coupling efficiencies. As a result, it might be possible to further reduce the threshold in more optimally coupled structures. The effect of optimization of coupling will be part of a future study employing an improved experimental setup.

The previously described embodiments of a doped sol gel coated spherical micro-cavity resonator and a doped sol gel coated planar microtoroid resonator that can be fabricated on a chip, such as a silicon chip, provide a number of improvements over conventional resonators and coating techniques. For example, some conventional systems are limited in that they are only able to coat spherical resonators, but are not able to coat other resonator shapes, such as toroids. The described embodiments in the specification can coat spherical, toroid and other resonator shapes. Further, these various resonator shapes can be coated with materials that are more compatible with optical applications rather than specific polymers and chemically sensitive materials. Additionally, the sol gel solution can be a host to various dopants so that various dopants and dopant combinations can be used to produce a gain medium and functionalize resonator surfaces for various wavelengths and applications, with precise dopant control, thereby serving as a substitute for ion implantation.

Moreover, by controlling the thickness of the doped sol gel coating and dopant concentration the dynamics of laser emission can be controlled so that both pulsation mode and continuous modes can be utilized. The combination of the planar configuration of microtoroid resonators and ultra-high Q factors of toroid-shaped micro-resonators also enables these devices to be efficiently and consistently processed with known wafer processing techniques. Further, the large transparency window of silica enable these devices to be utilized in various photonics applications, as well as in fundamental studies. Electrical functionality can also be introduced to integrate control functions with the ultra-high-Q micro-cavities. For example, the ultra-high Q micro-cavity can serve as atomic traps on a chip for chip-scale integration of cQED experiments and related devices.

Thus, doped sol gel coated micro-resonators are flexible and adaptable for use in various applications since their surfaces can be functionalized to have transmission spectra at various wavelengths. Optically active dopants, such as erbium, ytterbium, neodymium, and combinations thereof can be added to sol gel to functionalize micro-resonators as necessary to operate at various wavelengths, for example, wavelengths used in telecommunications, environmental, chemical, and biological sensing systems.

Although references have been made in the foregoing description to various embodiments, persons of ordinary skill in the art will recognize that insubstantial modifications, alterations, and substitutions can be made to the described embodiments without departing from the invention as recited in the accompanying claims. For example, other optical materials besides silica can be utilized, and other substrates besides silicon may be suitable depending on the particular application of the device or integration and coupling considerations. Moreover, various doped sol gel coatings of various thicknesses can be applied to various sizes and shapes high and ultra-high Q micro-cavities, including spherical and toroid shapes and planar micro-cavities, in order to functionalize resonator surfaces.

1. A micro-cavity resonator, comprising:
an optical micro-cavity;
a dopant; and
a sol gel solution, wherein the sol gel solution hosts the dopant, and at least a portion of the micro-cavity is coated with the doped sol gel solution, and whereby optical energy travels along an inner surface of the coated micro-cavity at a wavelength that is influenced by the dopant in the sol gel coating.

2. The resonator of claim 1, the dopant comprising a rare earth element.

3. The resonator of claim 2, the rare earth element comprising erbium.

4. The resonator of claim 3, the concentration of erbium in the sol gel solution being about 10¹⁸ to 10²² cm³.

5. The resonator of claim 3, wherein the erbium doped sol gel solution coated micro-cavity emits an output at a wavelength of about 1.5 to 1.6 micrometers.

6. The resonator of claim 1, a thickness of the sol gel coating being at least about 0.5 micrometer.

7. The resonator of claim 1, the micro-cavity having a Q factor of about 10⁶ to 10⁷.

8. The resonator of claim 1, the micro-cavity comprising a planar micro-cavity.

9. The resonator of claim 1, the micro-cavity comprising silica.

10. The resonator of claim 1, the micro-cavity comprising a spherical micro-cavity.

11. The resonator of claim 1, the micro-cavity comprising a toroid-shaped micro-cavity.

12. The resonator of claim 1, the entire micro-cavity surface being coated with the doped sol gel solution.

13. The resonator of claim 1, a resonant mode within the coated micro-cavity comprising a whispering-gallery mode.

14. A micro-cavity resonator, comprising:
a spherical optical micro-cavity;
a sol gel solution; and
a dopant,
wherein the sol gel solution hosts the dopant, and at least a portion of the spherical micro-cavity is coated with the doped sol gel solution, whereby the doped sol gel coating functionalizes a gain of the spherical micro-cavity, and optical energy travels along an inner surface of the coated micro-cavity at a wavelength influenced by the doped sol gel coating.

15. The resonator of claim 14, the dopant comprising erbium.

16. The resonator of claim 15, the concentration of erbium in the doped sol gel solution being about 10¹⁸ to 10²² cm⁻³.

17. The resonator of claim 16, wherein the coated spherical micro-cavity emits an output at a wavelength of about 1.5 to about 1.6 micrometers.

18. The resonator of claim 14, a thickness of the doped sol gel coating being at least about 0.5 half micrometer.

19. The resonator of claim 14, the spherical micro-cavity having a Q factor of about 10⁶ to 10⁷.

20. The resonator of claim 14, the spherical micro-cavity comprising silica.

21. The resonator of claim 14, the spherical micro-cavity having a diameter of about 25 to 200 μm, wherein a thickness of the doped sol gel coating is at least about half micrometer.

22. The resonator of claim 14, the entire spherical micro-cavity surface being coated with the doped sol gel solution.

23. The resonator of claim 14, a resonant mode within the coated spherical micro-cavity comprising a whispering-gallery mode.

24. A micro-cavity resonator, comprising:
a micro-cavity;
a substrate, wherein portions of the substrate located below the micro-cavity are removed to form a pillar, the pillar supporting the micro-cavity;
a sol gel solution; and
a dopant,
wherein the sol gel solution includes the dopant and at least a portion of the micro-cavity is coated with the doped sol gel solution, whereby optical energy travels along an inner surface of the coated micro-cavity and has a wavelength influenced by the dopant in the sol gel coating.

25. The resonator of claim 24, the dopant comprising erbium.

26. The resonator of claim 25, the concentration of erbium in the doped sol gel coating being about 10¹⁸ cm⁻³ to 10²² cm⁻³.

27. The resonator of claim 24, wherein the coated spherical micro-cavity emits an output at a 0 wavelength of about 1.5 to about 1.6 micrometers.

28. The resonator of claim 24, a thickness of the doped sol gel coating being at least about 0.5 micrometer.

29. The resonator of claim 24, the micro-cavity comprising a high Q micro-cavity.

30. The resonator of claim 24, the micro-cavity having a Q factor of about 10⁶ to 10⁸.

31. The resonator of claim 24, the micro-cavity comprising silica.

32. The resonator of claim 24, a majority of the micro-cavity surface having the doped sol gel coating.

33. The resonator of claim 24, the entire micro-cavity surface being coated with the doped sol gel solution.

34. The resonator of claim 24, the micro-cavity having a toroid shape.

35. The resonator of claim 34, the toroid-shaped micro-cavity having a thickness of about 0.5 to about ten micrometers.

36. The resonator of claim 24, the micro-cavity being substantially parallel to a top surface of the pillar.

37. The resonator of claim 24, wherein a periphery of the micro-cavity extends beyond a top of the pillar.

38. The resonator of claim 24, a resonant mode within the coated micro-cavity comprising a whispering-gallery mode.

39. The resonator of claim 24, the substrate comprising a silicon substrate.

40. The resonator of claim 24, the pillar having an isotropic surface.

41. The resonator of claim 24, the pillar having a tapered shape.

42. The resonator of claim 24, the micro-cavity comprising a disk, wherein a diameter of the disk becomes smaller when heated.

43. The resonator of claim 42, wherein the diameter of the disk decreases until the molten disk material collapses, after which the diameter remains substantially constant.

44. The resonator of claim 42, the heated disk sections forming a toroid micro-cavity.

45. The resonator of claim 24, the micro-cavity being substantially circular and having a diameter of about 25 micrometers to about 200 micrometers.

46. A method of functionalizing a surface of a micro-cavity, comprising:
providing the micro-cavity;
providing a sol gel solution;
providing a dopant;
introducing the dopant into the sol gel solution; and
coating at least a portion of the micro-cavity with the doped sol gel solution, whereby optical energy travels along an inner surface of the coated micro-cavity at a wavelength that is influenced by the dopant in the sol gel coating.

47. The method of claim 46, providing the micro-cavity further comprising providing a spherical micro-cavity.

48. The method of claim 46, providing the micro-cavity further comprising providing a toroid-shaped micro-cavity.

49. The method of claim 46, providing the micro-cavity further comprising providing a micro-cavity that is supported by a pillar.

50. The method of claim 49, providing the micro-cavity further comprising providing a micro-cavity that includes a periphery that extends beyond a top of the pillar.

51. The method of claim 46, wherein providing the doped sol gel solution further comprises providing an erbium doped sol gel solution.

52. The method of claim 51, wherein providing the erbium doped sol gel solution further comprises providing an erbium doped sol gel solution produced by the following steps:
hydrolyzing tetraethoxysilane (TEOS) in water under an acid condition with a co-solvent;
adding erbium ions to the hydrolyzed tetraethoxysilane;
stirring the mixture of the erbium ions and the hydrolyzed tetraethoxysilane; and
aging the stirred mixture, thereby forming an erbium doped silica sol gel solution.

53. The method of claim 52, wherein hydrolyzing further comprises hydrolyzing tetraethoxysilane (TEOS) in water under an acid condition with isopropanol as the co-solvent.

54. The method of claim 52, wherein adding erbium ions further comprises adding ErNO₃.5H₂O to the hydrolyzed TEOS solution

55. The method of claim 52, wherein stirring the mixture further comprises stirring the mixture at about 70° C.

56. The method of claim 52, wherein aging the stirred mixture further comprises aging the stirred mixture at about ambient temperature for about three to ten hours.

57. The method of claim 52, wherein coating the micro-cavity surface further comprises immersing the micro-cavity in the doped sol gel solution.

58. The method of claim 46, wherein immersing further comprises
immersing the micro-cavity into the doped sol gel solution for about 20 minutes, and
heating the micro-cavity in an oven at about 160° C. for 10 minutes.

59. The method of claim 46, wherein the immersing step results in application of a doped sol gel solution coating having a thickness of about 0.3 μm/cycle.

60. The method of claim 46, further comprising repeating the coating step until a desired doped sol gel solution coating thickness is achieved.

61. The method of claim 46, further comprising irradiating the coated micro-cavity with a laser.

62. The method of claim 61, further comprising inducing flow of the doped sol gel coating.

63. The method of claim 62, further comprising forming a toroid-shaped micro-cavity as a result of reflowing the doped sol gel coating.
